(19) United States
(12) Patent Application Publication
(10) Pub. No.: US 2023/0281474 A1
(43) Pub. Date: Sep. 7, 2023

(54) Prediction of Properties of a Chemical Mixture

(71) Applicant: BASF COATINGS GMBH, Münster (DE)

(72) Inventors: Bernhard STEINMETZ, Münster (DE); Michael BRUENNEMANN, Münster (DE)

(21) Appl. No.: 17/999,515

(22) PCT Filed: May 20, 2021
(86) PCT No.: PCT/EP2021/063403

§ 371 Date: Nov. 21, 2022

(30) Foreign Application Priority Data
May 22, 2020 (EP) 20176111.1

(51) Int. Cl. G06N 5/022

(52) U.S. Cl. CPC G06N 5/022

(57) ABSTRACT

Disclosed herein is a computer-implemented method for training a data-driven model for predicting properties of a chemical mixture. The method includes the steps of obtaining data including history and/or calibration data of a plurality of chemical mixture recipes and properties of each chemical mixture recipe, with each chemical mixture recipe including two or more ingredients, assigning at least one ingredient in each chemical mixture recipe to one of pre-defined substance clusters, each pre-defined substance cluster representing one ingredient or a group of ingredients having similar chemistry, revising each chemical mixture recipe by replacing the at least one ingredient with the assigned pre-defined substance cluster, and providing the revised chemical mixture recipes, together with the properties of the chemical mixture recipes, to a machine learning process in order to train a data-driven model, which is usable for predicting characteristics of properties of a new chemical mixture.

### FIELD OF THE INVENTION

The present invention generally relates to predicting properties of a chemical mixture and in particular to a computer-implemented method for training a data-driven model for predicting properties of a chemical mixture and an associated device, a computer-implemented method for predicting properties of a chemical mixture and an associated device, a computer program product, and a computer readable medium.

### BACKGROUND OF THE INVENTION

Chemical mixtures, such as automotive paints, nutrition multi-component mixture, etc., are commonly formulated to achieve desirable properties represented by property measurements. A great deal of effort, however, must be spent by laboratory personnel developing these formulas to provide the correct balance of properties.

For example, an automotive paint or coating formulation comprises a complex mixture of colorants (tints), binders, additives and solvents formulated to provide a balance of properties for colour match, appearance, durability, application, and film properties. Models are available for quantitative prediction of the colour of a mixture, but not other properties. Hence, labour-intensive verification experiments are required to measure a coating formulation’s properties to assure the values are within acceptable limits.

Such experiments are needed because the relationships between the mixture components and the measured properties are typically complex and unknown. In these cases, it would be advantageous to develop predictive models that are capable of relating the mixture components to the properties so that the properties of new mixtures can be estimated.

### SUMMARY OF THE INVENTION

There may be a need to predict properties of a chemical mixture.

The object of the present invention is solved by the subject-matter of the independent claims, wherein further embodiments are incorporated in the dependent claims. It should be noted that the following described aspects of the invention apply also for the computer-implemented method for training a data-driven model for predicting properties of a chemical mixture and the associated device, the computer-implemented method for predicting properties of a chemical mixture and the associated device, the computer program product and the computer readable medium.

According to a first aspect of the present invention, there is provided a computer-implemented method for training a data-driven model for predicting properties of a chemical mixture. The method comprises the steps of:
obtaining data comprising history and/or calibration data of a plurality of chemical mixture recipes and properties of each the chemical mixture recipe, wherein each chemical mixture recipe comprises two or more ingredients;
assigning at least one ingredient in each chemical mixture recipe to one of pre-defined substance clusters, wherein each pre-defined substance cluster represents a single ingredient or a group of ingredients having similar chemistry;
revising each chemical mixture recipe by replacing the at least one ingredient with the assigned pre-defined substance cluster; and
providing the revised chemical mixture recipes, together with the properties of the chemical mixture recipes, to a machine learning process in order to train a data-driven model, which is usable for predicting properties of a new chemical mixture.

In other words, empirical data may be obtained e.g. from a library or database (such as commercial databases or a company’s proprietary database). The empirical data comprises history and/or calibration data from history and/or calibration experiments. Instead of using the empirical data directly to train a data-driven model for predicting properties of a chemical mixture, the proposed method modifies the empirical data by assigning at least one ingredient in each chemical mixture recipe to a pre-defined chemical substance cluster, and replaces the at least one ingredient with the assigned pre-defined substance cluster in each chemical mixture recipe. For example, a chemical mixture recipe may comprise ingredient A, ingredient B, and Ethanol. The Ethanol may be assigned to a solvent cluster named “alcohol”. Therefore, the revised chemical mixture recipe comprising ingredient A, ingredient B, and the substance cluster “alcohol” is used as the training data. In this way, the data-driven model does not further distinguish ingredients of the same substance, which have similar chemistry. For example, 70 resins may be clustered into 15 resin clusters. Therefore, instead of considering 70 resins, some of which may have similar chemistry, the proposed training method only considers 15 resin clusters. This may greatly reduce the complexity of the training dataset and therefore further reduce the complexity of the data-driven model.

According to an embodiment of the present invention, the computer-implemented method further comprises the step of identifying, based on the training, a correlation between at least one pre-defined substance cluster and one or more properties.

In other words, it is proposed to look at the percentage of the substance cluster, e.g. resin cluster, or additive cluster, or solvent cluster, inside a formulation to understand the effect of the substance cluster in different formulations. For example, it may be determined whether the amount of the substance cluster is positively correlated or negatively correlated with a property. If the amount of the substance cluster is positively correlated with a property, increasing the amount of the substance cluster may achieve a better, i.e. more desired, characteristic of the property. On the other hand, if the amount of the substance cluster is negatively correlated with a property, increasing the amount of the substance cluster inside the formulation may achieve a worse, i.e. less undesired, characteristic of the property.

According to an embodiment of the present invention, the properties of each chemical mixture recipe further comprise, for each measured property, a respective performance score indicative of a performance evaluation of the respective chemical mixture recipe.

For example, the performance score may be an ordinal measurement, such as on a decimal category ordinal scale from 1 (very good, i.e. desirable) to 5 (very bad, i.e. undesirable). The inclusion of the performance score in the properties allows the evaluation of the performance of a chemical mixture recipe.

The performance score for each chemical mixture recipe may be given e.g. based on the feedback of the customer, expectation or specification of the customer, or comparison to competitor’s material.

According to an embodiment of the present invention, at least one ingredient selected from a resin and/or an additive is represented by a substance cluster.

According to an embodiment of the present invention, the chemical mixture comprises a paint formulation.

For example, the paint formulation may be an automotive paint formulation.

According to an embodiment of the present invention, the properties of a paint formulation comprise properties of a wet paint and/or properties of coating formed therefrom.

According to an embodiment of the present invention, the chemical mixture comprises at least one of: an agricultural multi-component mixture, a pharmaceutical multi-component mixture, a nutrition multi-component mixture, an ink multi-component mixture, a chemical mixture for construction purposes, and a chemical mixture used inside oil production.

According to an embodiment of the present invention, the data-driven model comprises a rule-based machine learning model.

The rule-based machine learning model comprises any machine learning method that identifies, learns, or evolves ‘rules’ to store, manipulate or apply.

According to an embodiment of the present invention, the rule-based machine learning model comprises at least one of: learning classifier systems, association rule learning, and artificial immune systems.

According to a second aspect of the present invention, there is provided a computer-implemented method for predicting properties of a chemical mixture. The method comprises the steps of
obtaining a chemical mixture recipe comprising two or more ingredients;
assigning at least one ingredient to one of pre-defined substance clusters, wherein each pre-defined substance cluster represents a single ingredient or a group of ingredients having similar chemistry;
revising the chemical mixture recipe by replacing the at least one ingredient with the assigned pre-defined substance cluster;
processing the revised chemical mixture recipe with a data-driven model to predict property measurements of the chemical mixture recipe, wherein the data-driven model has been trained according to a method according to any one of the preceding claims; and
outputting the predicted property measurements of the chemical mixture recipe.

In other words, the trained data-driven model for predicting properties of a chemical mixture also does not differentiate ingredients of the same cluster, as these ingredients have similar chemistry.

According to an embodiment of the present invention, the computer-implemented method further comprises the steps of comparing the predicted property measurements to property performance targets and adjusting the chemical mixture recipe to meet the property performance targets.

According to an embodiment of the present invention, the properties of each chemical mixture recipe further comprise, for each measured property, a respective performance score indicative of a performance evaluation of the respective chemical mixture recipe.

According to an embodiment of the present invention, at least one ingredient selected from a resin and/or an additive is represented by a substance cluster.

According to an embodiment of the present invention, the chemical mixture comprises a paint formulation.

According to an embodiment of the present invention, the properties of a paint formulation comprise properties of a wet paint and/or properties of coating formed therefrom.

According to an embodiment of the present invention, the chemical mixture comprises at least one of: an agricultural multi-component mixture, a pharmaceutical multi-component mixture, a nutrition multi-component mixture, an ink multi-component mixture, a chemical mixture for construction purposes, and a chemical mixture used inside oil production.

According to an embodiment of the present invention, the data-driven model comprises a rule-based machine learning model.

According to an embodiment of the present invention, the rule-based machine learning model comprises at least one of: learning classifier systems, association rule learning, and artificial immune systems.

According to a third aspect of the present invention, there is provided a device comprising a training module configured to perform a method according to the first aspect and any associated example.

According to a fourth aspect of the present invention, there is provided a device comprising a prediction module configured to perform a method according to the second aspect and any associated example.

According to another aspect of the present invention, there is provided a computer program product comprising a computer program with program code for performing a method as described above and below.

According to a further aspect of the present invention, there is provided a computer readable medium having stored the program element.

Advantageously, the benefits provided by any of the above aspects equally apply to all of the other aspects and vice versa.

As used herein, the term “learning” in the context of machine learning refers to the identification and training of suitable algorithms to accomplish tasks of interest. The term “learning” includes, but is not restricted to, association learning, classification learning, clustering, and numeric prediction.

As used herein, the term “machine-learning” refers to the field of the computer sciences that studies the design of computer programs able to induce patterns, regularities, or rules from past experiences to develop an appropriate response to future data, or describe the data in some meaningful way.

As used herein, the term “data-driven model” in the context of machine learning refers to a suitable algorithm that is learnt on the basis of appropriate training data.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a flowchart that illustrates a computer-implemented method according to some embodiments of the present disclosure.

FIG. 2 is a flowchart that illustrates a computer-implemented method according to some embodiments of the present disclosure.

FIG. 3 illustrates a chemical structure of melamine formaldehyde resins.

FIG. 4 illustrates the central moiety of the chemical structure of Diketo-Pyrrolo-Pyrrol pigments.

FIG. 5 illustrates that one criteria for the attribution to the same cluster of pigments can be the same central moiety of different pigments.

FIG. 6 illustrates a training module and a prediction module according to some embodiments of the present disclosure.

### DETAILED DESCRIPTION OF EMBODIMENTS

According to a first aspect of the present disclosure, there is provided a computer-implemented method 100 for training a data-driven model for predicting properties of a chemical mixture. The computer-implemented method comprises the steps of:
obtaining 110 data comprising history and/or calibration data of a plurality of chemical mixture recipes and properties of each chemical mixture recipe, wherein each chemical mixture recipe comprises two or more ingredients;
assigning 120 at least one ingredient in each chemical mixture recipe to one of pre-defined substance clusters, wherein each pre-defined substance cluster represents a single ingredient or a group of ingredients having similar chemistry;
revising 130 each chemical mixture recipe by replacing the at least one ingredient with the assigned pre-defined substance cluster; and
providing 140 the revised chemical mixture recipes, together with the properties of the chemical mixture recipes, to a machine learning process in order to train a data-driven model, which is usable for predicting properties of a new chemical mixture.

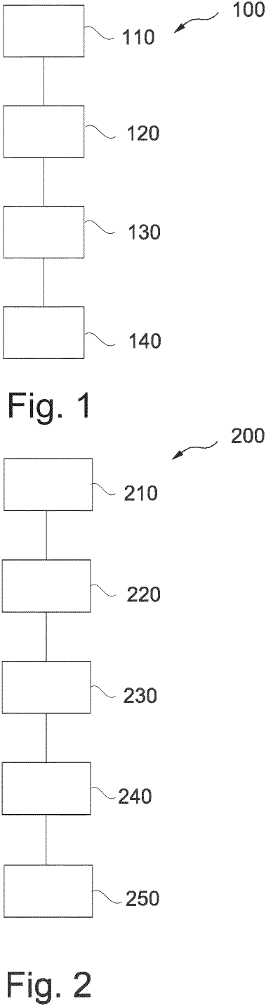

FIG. 1 is a flowchart that illustrates a computer-implemented method 100 according to the first aspect of the present disclosure.

### Empirical Data Collection

In step 110, empirical data may be obtained e.g. from a library or database (such as commercial databases or a company’s proprietary database). The empirical data comprises history and/or calibration data from history and/or calibration experiments of a plurality of chemical mixture recipes and properties of each chemical mixture recipe.

Each chemical mixture recipe comprises two or more ingredients. In some examples, a single chemical mixture recipe may comprise up to fifty different raw materials, i.e. ingredients. The two or more ingredients are expressed as fractional concentrations of the total amount of the chemical mixture. In general, the property of a chemical mixture depends on the ingredient component fractional concentrations rather than the total amount of the chemical mixture. Mixture formulas may be expressed in weight, volume, or other quantity units. The fractional concentration is simply the quantity of an ingredient in the chemical mixture divided by the total quantity of the mixture. The sum of the fractional concentrations will be unity. Fractional concentrations are continuous variable in the range between 0 and 1.

Properties of the chemical mixture may be any measurable characteristic. The characteristic may be a continuous, ordinal, or nominal measurement. For example, a formulated coating could have a measurement of the viscosity of the liquid mixture on a continuous scale. For example, the measurement of orange peel of the applied coating film may be on a decimal category ordinal scale from 1 (very unsmooth) to 10 (very smooth). In another example, the properties of each chemical mixture recipe further comprise, for each measured property, a respective performance score indicative of a performance evaluation of the respective chemical mixture recipe, e.g. from 1 (very good) to 5 (very bad). An example of a nominal measurement may be the coded categories of pass or fail for observation of some defect.

In some examples, the chemical mixture may be automotive coating formulations. Properties of automotive coating formulations may include, for example, physical properties (viscosity, sag) and appearance (hiding, gloss, distinctness of image) which are dependent on chemical mixture recipe, e.g. paint ingredient amounts.

Table 1 shows exemplary properties and corresponding attributes for waterborne basecoats.

TABLE 1

Exemplary properties and corresponding attributes for waterborne basecoats.

| | | |
|---|---|---|
| Main property | Corresponding attribute | Evaluated system |
| Stability | Viscosity stability after storing | Wet paint |
| Stability | Viscosity stability after storing at elevated temperature | Wet paint |
| Stability | Viscosity stability after shear stress treatment | Wet paint |
| Stability | Colour stability after storing | Wet paint |
| Stability | Colour stability after storing at elevated temperature | Wet paint |
| Stability | Colour stability after shear stress treatment | Wet paint |
| Stability | Flop stability after storing | Wet paint |
| Stability | Flop stability after storing at elevated temperature | Wet paint |
| Stability | Flop stability after shear stress treatment | Wet paint |
| Stability | Seeding robustness after storing | Wet paint |
| Stability | Seeding robustness after storing at elevated temperature | Wet paint |
| Stability | Seeding robustness after shear stress treatment | Wet paint |
| Application property | Sag resistance | Applied paint |
| Application property | Popping resistance | Applied paint |
| Application property | Pinhole resistance | Applied paint |
| Application property | Crater robustness | Applied paint |
| Application property | Slumping resistance | Applied paint |
| Application property | Dirt coverage ability | Applied paint |
| Application property | Sanding marks coverage ability | Applied paint |
| Application property | Overspray robustness | Applied paint |
| Application property | Stability against different climate conditions at application | Applied paint |
| Application property | Stability against different spray parameters | Applied paint |
| Application property | Stability against different application processes | Applied paint |
| Application property | Stability against different build-ups | Applied paint |
| Application property | Stability against different hologramming | Applied paint |
| Adhesion / Cohesion | Scratch resistance on different surfaces (on ED coat, on primer, on clearcoat), whereby the surfaces are baked at different conditions | Baked paint |
| Adhesion / Cohesion | Stone chip resistance on different surfaces | Baked paint |
| Adhesion / Cohesion | Steam jet resistance on different surfaces | Baked paint |
| Adhesion / Cohesion | Impact resistance on different surfaces | Baked paint |
| Adhesion / Cohesion | Hardness value on different surfaces | Baked paint |
| Adhesion / Cohesion | All of the mentioned adhesion values after humidity treatment / storage | Baked paint |
| Adhesion / Cohesion | All of the mentioned adhesion values after weathering | Baked paint |
| Colour / Appearance | Appearance measured in wavelength of the resulting buildup | Baked paint |
| Colour / Appearance | Colour measured in the so-called Cie-Lab scale | Baked paint |
| Colour / Appearance | Colour stability after weathering or UV treatment | Baked paint |
| Colour / Appearance | Mottling | Baked paint |

One skilled in the art would understand that the method of the present disclosure is also useful for predicting the properties of other kinds of chemical mixtures, whether solids or liquids, including, but not limited to, other types of paints and coatings, inks including ink jet inks, alcohols, diesel fuel, oil, plastics, polymer blends, films, and the like.

Some further examples of the chemical mixtures and the measured properties will be described below:

### 1. Agricultural Multi-Component Mixtures

For example, there are mixtures used for agricultural purposes like formulations used as sprays for treating crops with insecticides, fungicides and so on. Thereby on the one side the sprayability of the active ingredients is guaranteed by the residual components inside the formulation. I.e. the different other components of the formulation besides the active ingredient are used to obtain a formulation, which is applicable under the given process of spraying. I.e. the sprayability (e.g. droplet size formation, ease of forming such a droplet and so on) might be properties, which are influenced by the different components of such a formulation together with the nature of the active ingredient.

Furthermore, also the adsorption of the sprayed formulation on the plant and the absorption, which is resorption in this context, of the active ingredient or complete sprayed formulation are depending on the active ingredient and the residual components in the formulation. Moreover, also the target-oriented way – or better said movement of the active ingredient to the targeted part of the cell – of the active ingredient inside a plant / organism will be influenced by the residual components inside such a formulation. I.e. the speed of effect generation and the effect generation itself are depending on these shares of the formulation.

### 2. Pharmaceutical Multi-Component Mixtures

Also, here the components being present in a pharmaceutical formulation besides the active ingredient influence the complete lifecycle of such a pharmaceutical - herein, from preparation to excretion or “digestion”.

For example, these formulation shares define, whether an active ingredient is provided as pill, suppositories or as a liquid, which mostly is a dispersion of the active ingredient.

Furthermore, these formulation shares define, where inside an organism the active ingredient is set free and where it can be absorbed respectively resorbed.

Finally, these formulation shares define, to which parts inside a body respectively cell the active ingredient is transported and there digested to show the wished effect; or, if it is not “digested” inside the organism at all and excreted without “digestion”.

Each of these properties may be important to find the right formulation, i.e. composition of the pharmaceutical multi-component mixtures.

### 3. Nutrition Multi-Component Mixtures

A lot of foods can be looked at as multi-component mixtures comprising different kind of chemical sub-groups necessary for our organisms to work properly. Nutrition additives like e.g. vitamins, mineral nutrients and so on are a part of foods also, whereby it is important to integrate these into these food “formulations” in a way that these are available at the right parts of the organism. Again, both parameters can be influenced by the residual shares of the food “formulations”. For example, the right way of offering mineral nutrients to an organism can guarantee a good resorption by the organism, whereas a worse way of offering can reduce the resorption, what then can cause health effects.

### 4. Inks as Multi-Component Mixtures

Similar, to paints also inks are multi-component mixtures, i.e. they can be defined as ink formulations also. Also, here the residual components beside the colour providing ingredients –in this case mostly dyes – guarantee the stability of the ink, the process-ability and the fixation on the to-be-inked surface. Thus, the different tasks and properties are very similar to the ones described in the chapter about properties of coatings, described in more detail for waterborne basecoats in table 1.

Here, the properties being of specific importance, are properties like adhesion to the to-be-inked surface, sagging resistance or viscosity stability of the formulation after application and lightfastness of the resulting print, i.e. non-fading of the resulting print.

### 5. Chemical Mixtures for Construction Purposes

Also, a lot of materials used inside construction applications can be looked at as chemical mixtures. E.g. concrete is formed out of a mixture of cement, rockets of different sizes and water. Furthermore, a modern concrete formulation also contains concrete additions and concrete admixtures, both, additives for these formulations to trigger and tailor-make specific properties of the concrete formulations. Such properties are for example the application behaviour, the settling behaviour, the hardening, the tensile strength, the bending property and the durability of the concrete in wet or in dried form. All these properties can be influenced by concrete additions and concrete admixtures. Whereas the substances used as concrete addition materials are mostly inorganics like e.g. rock flour, fly ash or silica fume, the substances used as concrete admixture materials can also be of organic character, like e.g. acrylics or other oligo- or polymeric substances.

A related application may also be chemical mixtures used as materials for plastering. Thereby, also formulations are used, which are similar to concrete formulations. However, these plaster mortars are usually limited with respect to the size of the rockets. I.e. the rock’s aggregate is limited to a size of 4 mm, no bigger sizes are allowed to be used for these mortars. The main properties, which need to be achieved also by the use of the right additives, which are very similar to the ones mentioned above, are mainly in the area of application properties respectively workability. Pumpability, smoothing property, but also adhesion properties are evaluated usually during the development of such plastering formulations.

### 6. Chemical Mixtures Used Inside Oil Production

Also, in oil production chemical mixtures are used to optimize the degree of efficiency of oil extraction. In fracking and in conventional oil extraction methods, especially at late stages of the lifecycle of a wellbore, the efficiency level is elevated by pumping of these formulations into the wellbore. Thereby, mainly water comprising organic polymers are used. Overall, the efficiency level of oil production is a parameter for the effectiveness of the additives used. In a detail view, properties like the ability to release oil from stones or the ability to generate pressure and viscosity under such conditions might be important properties.

### Substance Cluster

The collected empirical data is not directly used as the training data. Rather, in step 120, at least one ingredient in each chemical mixture recipe is assigned to one of pre-defined substance clusters. Each pre-defined substance cluster may represent a group of ingredients having similar chemistry. However, it should be mentioned that a substance cluster might also be a single ingredient only, i.e. a cluster may exist of one chemical only. This might be the case, if the chemical nature of the ingredient is not comprising similarity to the one of other ingredients and thus, cannot be attributed to a cluster. E.g. the cluster of “oligo- or polyethylene glycols” consists of only Triethylene glycol, because this is the only ingredient used out of the chemical group of oligo- or polyethylene glycols.

For example, ingredients like a solely methylated melamine formaldehyde resins having no free OH-groups, and a solely butylated one having no free OH-groups might both be looked at as highly etherified melamine formaldehyde resins, but due to their different etherification their physical and/or chemical behaviour will differ from each other. Thus, there are two different clusters resulting out of this.

For example, a substance named “alcohol” may include Ethanol and Methanol, as they have similar chemical structures and are completely soluble and mixable with water. Further cluster examples will be described hereafter.

Ingredients may be clustered in various manners. For example, ingredients may be clustered using an automatic chemical clustering algorithm. For example, an expert may define a plurality of substance clusters, each of which has a representative ingredient that is sufficiently representative of the whole cluster. The automatic chemical clustering algorithm may compare ingredients of a chemical mixture recipe with the representative substance of each substance cluster e.g. based on e.g. binary fingerprints, graph properties, or maximum common substructures, and assign the ingredient to a substance cluster if the similarity is within an acceptable limit.

In an example, a binary substructure fingerprint for chemical structures may be generated. A substructure is a fragment of a chemical structure. A fingerprint is an ordered list of binary (1/0) bits. Each bit represents a Boolean determination of, or test for, the presence of, for example, an element count, a type of ring system, atom pairing, atom environment (nearest neighbours), etc., in a chemical structure. These fingerprints may be used for similarity neighbouring and similarity searching.

In another example, the maximum common substructure may be used for clustering. The maximum common substructure is a graph-based similarity concept that is defined as the largest substructure (sub-graph) shared among two compounds, which may be used for the computation of the same similarity coefficients.

Alternatively or additionally, a person, such as a formulator, may assign the substance cluster to the ingredients of each collected chemical mixture recipe.

To facilitate understanding of the substance cluster described herein, exemplary substance clusters for ingredients of automotive paints will be described henceforth. An automotive paint or coating formulation comprises a complex mixture of resins, pigments, solvents, and additives formulated to provide a balance of properties for colour match, appearance, durability, application, and film properties.

### First Subgroup: Resins (i.e. Binding Agents)

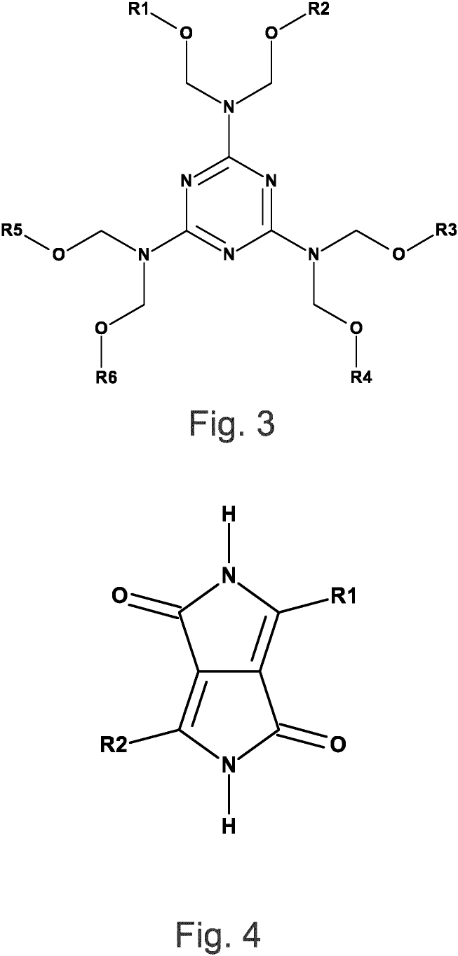

FIG. 3 illustrates a chemical structure of melamine formaldehyde resins (mfr), which are used as cross-linkers inside waterborne basecoat systems.

Thereby, R1, R2, R3, R4, R5 and R6 are selected out of the group of Methyl, Butyl or Hydrogen. By analytical comparison of the different raw materials, i.e. different mfr supplied from different suppliers, one can group, whether such an mfr is e.g. a solely methylated mfr having no free OH-groups, a solely butylated one having no free OH-groups and so on. Based on this, an attribution to such a cluster can be done. For completeness reasons it must be mentioned that furthermore, amine groups, oligo formaldehyde moieties and structures obtained by self-cross-linking reactions can be comprised inside typical melamine formaldehyde resins. All of these groups can be used for the definition of a cluster.

Further examples include polyurethane resins, which are used as “resins = binding agents” inside waterborne basecoat systems. These resins are characterized by the content of so-called urethane bondages, which are achieved by reaction of alcohols (characterized by free OH-groups) with isocyanates (characterized by NCO-groups). However, the chemical structure of isocyanates as well as alcohols used for the preparation of such polyurethanes can be quite different. Thus, key indices of the educts for this synthesis (OH-number, NCO-number, molecular weight, glass transition number, and molecular ratio of the educts, etc.) are defining the structure and nature of the polyurethane. If these key indices are known, a “similarity” due to very similar key indices can be claimed and an attribution to a certain cluster can be done.

For example, there are three different polyurethanes used inside waterborne basecoat systems, which are described in WO 92/15405 A1 - page 14, line 13 to page 15, line 20. Such polymers are then described as similar.

In this way, 70 different resins may be clustered into e.g. 15 resin clusters.

### Second Subgroup: Pigments

Here also the attribution to a certain cluster is done based on the chemical structure of the pigment itself. E.g. white pigments are usually based on Titanium dioxide, however, there are differences in each particular type with respect to surface treatment and/or particle size distribution and so on. However, in the end these different types are all Titanium dioxides and thus the chemical behaviour of these pigments is very similar, i.e. an attribution to a certain cluster based on this similarity is reasonable.

A second example may be Diketo-Pyrrolo-Pyrrol pigments, which is defined by the chemical basic structure shown in FIG. 4.

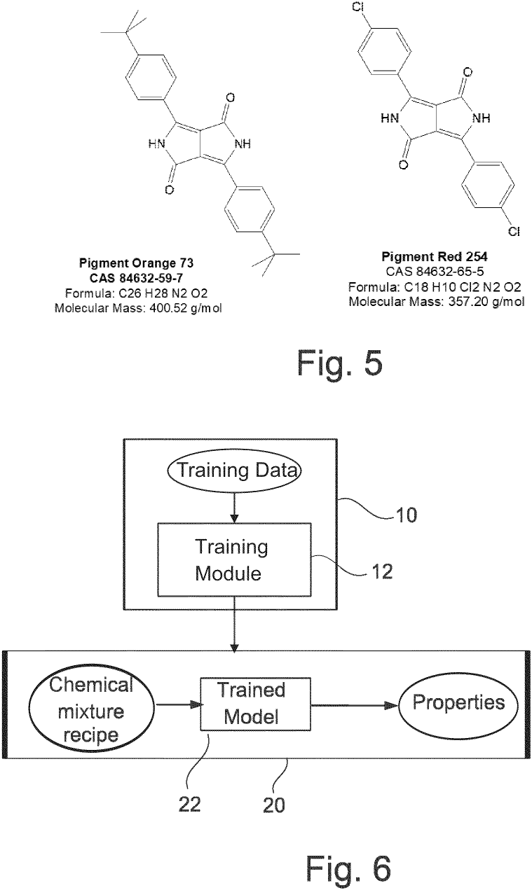

FIG. 4 illustrates the central moiety of the Diketo-Pyrrolo-Pyrrol pigments. Whereas the colour of the particular pigments is depending on the chemical structures of R1 and R2, which can both vary and thereby form different pigments, the chemical behaviour of these pigments is pretty much depending on this central moiety. Thus, the attribution to a certain cluster is done based on this central unit. Examples for this are illustrated in FIG. 5.

### Third Subgroup: Solvents

Solvents are clustered on the one side by their chemical nature, e.g. being an alcohol or an ester and on the other side by their physical properties. For example, alcohols can be looked at as water-soluble or insoluble substances depending on the chemical structure of the particular alcohol.

Ethanol and Methanol e.g. are completely soluble and mixable with water and thus, these would be attributed to the same cluster.

Another example is the attribution to alcohols not mixable or only very poor mixable with water, like e.g. 2-Ethylhexanol, 1-Octanol or Iso-tridecylalcohol.

### Fourth Subgroup: Additives

Herein the biggest variety is used inside the described matter. However, also here the attribution to a certain cluster is done by looking at the chemical structure of the substances. One example might be the polypropylene glycols used, which are Pluracol 1010, Uniol 1000 and Pluriol P900. All of those are polypropylene glycols, whereby the number behind the brand names indicate the average molecular weight of the polypropylene glycols present inside this raw material. Thus, the attribution to the cluster polypropylene glycols is done.

Another example is the cluster of modified siloxanes, whereby Byk-345, Byk-346 and Byk-347 are used for example hereby, which are all ethylene oxide modified siloxanes, i.e. based on this information the “similarity” and thereby the belonging to a specific cluster is decided.

In this way, more than 70 additives may be clustered into around 20 additive clusters.

### Training Data Preparation

In step 130, each chemical mixture recipe is revised by replacing the at least one ingredient with the assigned pre-defined substance cluster. In other words, the training dataset will be built using modified empirical data. In the training dataset, a single example of a set of chemical mixture recipe input and property output is called an exemplar. In each chemical mixture recipe input, if one ingredient of the chemical mixture recipe is assigned to a pre-defined substance cluster, the assigned substance cluster will replace the corresponding ingredient in the chemical mixture recipe.

For example, if a chemical mixture recipe comprises ingredient A, ingredient B, ingredient C, and methylated melamine formaldehyde resins having no free OH-groups, the corresponding chemical mixture recipe input may be ingredient A, ingredient B, ingredient C, and a substance group named “mfr-solely methylated”. For example, if a chemical mixture recipe comprises ingredient B, ingredient D, and solely butylated one having no free OH-groups, the corresponding chemical mixture recipe input may be ingredient B, ingredient D, and a substance group named “mfr-solely butylated”.

In other words, the training dataset does not differentiate ingredients of the same substance cluster, as these ingredients have similar chemistry. Accordingly, the complexity of the training dataset may be reduced, thereby also reducing the complexity of training process for the data-driven model.

### Data-Driven Model Training

In step 140, the revised chemical mixture recipes, together with the properties of the chemical mixture recipes will be provided to a machine learning process in order to train the data-driven model, which is usable for predicting properties of a new chemical mixture.

The term “data-driven model” in the context of machine learning refers to a suitable algorithm that is learnt on the basis of appropriate training data. In this case, such a learnt data-driven model is intended to predict properties of a chemical mixture based on the ingredients and substance cluster of the corresponding chemical mixture recipe.

For example, the data-driven model may be a rule-based machine learning model. The rule-based machine learning model may comprise any machine learning method that identifies, learns, or evolves ‘rules’ to store, manipulate or apply. The defining characteristic of a rule-based machine learner is the identification and utilization of a set of relational rules that collectively represent the knowledge captured by the system. This is in contrast to other machine learners that commonly identify a singular model that can be universally applied to any instance in order to make a prediction.

Rule-based machine learning approaches may include learning classifier systems, association rule learning, artificial immune systems, and any other method that relies on a set of rules, each covering contextual knowledge.

For example, association rule learning algorithms may be utilized for prediction with one or more machine learning algorithms selected from: feature evaluation algorithms, feature subset selection algorithms, Bayesian networks (see Cheng and Greiner (1999), Comparing Bayesian network classifiers. Proceedings UAI, pp. 101-107.), instance-based algorithms, support vector machines (see e.g., Shevade et al., (1999), Improvements to SMO Algorithm for SVM Regression. Technical Report CD-99-16, Control Division Dept of Mechanical and Production Engineering, National University of Singapore; Smola et al., (1998). A Tutorial on Support Vector Regression. NeuroCOLT2 Technical Report Series-NC2-TR-1998-030; Scholkopf, (1998). SVMs-a practical consequence of learning theory. IEEE Intelligent Systems. IEEE Intelligent Systems 13.4: 18-21; Boser et al., (1992), A Training Algorithm for Optimal Margin Classifiers V 144-52; and Burges (1998), A tutorial on support vector machines for pattern recognition. Data Mining and Knowledge Discovery 2 (1998): 121-67), vote algorithm, cost-sensitive classifier, stacking algorithm, classification rules, and decision tree algorithms (see Witten and Frank (2005), Data Mining Practical machine learning Tools and Techniques. Morgan Kaufmann, San Francisco, Second Edition.).

### Correlation Between Predefined Substance Clusters and Properties

Optionally, the computer-implemented method may comprise the step of identifying, based on the training, a correlation between at least one pre-defined substance cluster and one or more properties.

In an example, the correlation may allow to determine which raw materials are inside recipes assigned with a particular property value.

In another example, the correlation may allow to determine which combinations of raw materials are frequent for a particular property value.

In a further example, the correlation may allow to determine which raw materials might lead to good resp. bad property values. In other words, it may be determined which raw material is positively correlated with a property value and which raw material is negatively correlated with a property value.

E.g. the property “impact resistance”, which is very important for the quality of an automotive coating, was found to be correlated with the cross-linker amount and cross-linker nature inside a waterborne basecoat. Whereas higher cross-linking rations caused by higher amounts of cross-linkers like defined inside the cluster mfr-solely methylated lead to coatings with worse impact resistance, lower cross-linking ratios caused by lower amounts of cross-linkers like defined inside the cluster mfr-solely methylated lead to coatings with improved impact resistance.

### Prediction

When the data-driven model has been trained, it can provide a model of the relationship between chemical mixture recipe inputs and measured properties output. Note that in each chemical recipe input at least one ingredient is replaced by an assigned pre-defined substance cluster. In other words, the proposed trained data-driven model does not differentiate ingredients of the same substance cluster. This may reduce the complexity of the input data as well as the complexity of the data-driven model.

To this end, according to a second aspect of the present disclosure, there is provided a computer-implemented method 200 for predicting properties of a chemical mixture. The method comprises the steps of:
obtaining 210 a chemical mixture recipe comprising two or more ingredients;
assigning 220 at least one ingredient to one of pre-defined substance clusters, each pre-defined substance cluster representing one ingredient or a group of ingredients having similar chemistry;
revising 230 the chemical mixture recipe by replacing the at least one ingredient with the assigned pre-defined substance cluster;
processing 240 the revised chemical mixture recipe with a data-driven model to predict property measurements of the chemical mixture recipe, wherein the data-driven model has been trained according to a method according to the first aspect and any associated example; and
outputting 250 the predicted property measurements of the chemical mixture recipe.

FIG. 2 is a flowchart that illustrates a computer-implemented method 200 according to the second aspect of the present disclosure.

In step 210, a chemical mixture recipe is obtained. The chemical mixture recipe comprises two or more ingredients. Examples of the chemical mixture may include, but are not limited to, paint formulation, agricultural multi-component mixture, pharmaceutical multi-component mixture, nutrition multi-component mixture, ink multi-component mixture, chemical mixture for construction purposes, and chemical mixture used inside oil production.

In step 220, at least one ingredient of the chemical mixture recipe is assigned to one of pre-defined substance clusters. Each pre-defined cluster representing one ingredient or a group of ingredients having similar chemistry. For example, Ethanol and Methanol e.g. are completely soluble and mixable with water and thus, these would be attributed to the same cluster.

In step 230, the chemical mixture recipe is revised by replacing the at least one ingredient with the assigned pre-defined substance cluster. In other words, if one ingredient in the chemical mixture recipe is assigned to a substance cluster, the assigned substance cluster, instead of the ingredient, will be provided as input to the trained data-driven model.

In step 240, the revised chemical mixture recipe is processed with a data-driven model to predict property measurements of the chemical mixture recipe. The data-driven model has been trained according to a method according to the first aspect and any associated example. For example, if the data-driven model is a rule-based machine learning model, a set of relational rules will be derived from the training dataset. Based on these rules, the properties of new recipe compositions can be predicted in a high likelihood.

In step 250, the predicted property measurements of the chemical mixture recipe are provided.

Optionally, the computer-implemented method may comprise the steps of comparing the predicted property measurements to property performance targets and adjusting the chemical mixture recipe to meet the property performance targets.

The computer-implemented method 100, 200 may be implemented as a device, module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 100, 200 may be written in any combination of one or more programming languages, including an object oriented programming language such as JAVA, SMALLTALK, C++, Python, or the like and conventional procedural programming languages, such as the “C” programming language or similar programming languages.

It should also be understood that, unless clearly indicated to the contrary, in any methods claimed herein that include more than one step or act, the order of the steps or acts of the method is not necessarily limited to the order in which the steps or acts of the method are recited.

### Training Module

According to a third aspect of the present invention, there is provided a device 10 for training a data-driven model for predicting properties of a chemical mixture. The device comprises a training module 12 configured to perform a method according to the first aspect and any associate example.

FIG. 6 illustrates a device 10 according to the third aspect of the present disclosure. For example, an association rule learning model may be used as the data-driven model.

Thus, the training module 12 may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logical circuit, and/or other suitable components that provide the described functionality. Furthermore, such training module 12 may be connected to volatile or non-volatile storage, display interfaces, communication interfaces and the like as known to a person skilled in the art. A skilled person will appreciate that the implantation of the training module 12 is dependent on the compute intensity and latency requirements implied by the selection of signals used to represent positional information in a particular implementation.

### Prediction Module

According to a fourth aspect of the present invention, there is provided a device 20 comprising a prediction module 22 configured to perform a method according to the second aspect of the present disclosure and any associated example.

A device 20 according to the fourth aspect of the present disclosure is also illustrated in FIG. 3.

Thus, the prediction module 22 may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logical circuit, and/or other suitable components that provide the described functionality. Furthermore, such prediction module 22 may be connected to volatile or non-volatile storage, display interfaces, communication interfaces and the like as known to a person skilled in the art. A skilled person will appreciate that the implantation of the prediction module 22 is dependent on the compute intensity and latency requirements implied by the selection of signals used to represent positional information in a particular implementation.

All definitions, as defined and used herein, should be understood to control over dictionary definitions, definitions in documents incorporated by reference, and/or ordinary meanings of the defined terms.

The indefinite articles “a” and “an”, as used herein in the specification and in the claims, unless clearly indicated to the contrary, should be understood to mean “at least one”.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of”.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising”, “including”, “carrying”, “having”, “containing”, “involving”, “holding”, “composed of”, and the like are to be understood to be open-ended, i.e., to mean including but not limited to. Only the transitional phrases “consisting of” and “consisting essentially of” shall be closed or semi-closed transitional phrases, respectively.

Furthermore, in this detailed description, a person skilled in the art should note that quantitative qualifying terms such as “generally”, “substantially”, “mostly”, and other terms are used, in general, to mean that the referred to object, characteristic, or quality constitutes a majority of the subject of the reference. The meaning of any of these terms is dependent upon the context within which it is used, and the meaning may be expressly modified.

In another exemplary embodiment of the present invention, a computer program or a computer program element is provided that is characterized by being adapted to execute the method steps of the method according to one of the preceding embodiments, on an appropriate system. The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

All features can be combined to provide a synergetic effect that is more than the simple summation of the features.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A computer-implemented methodfor training a data-driven model for predicting properties of a chemical mixture, comprising:
obtainingdata comprising history and/or calibration data of a plurality of chemical mixture recipes and properties of each chemical mixture recipe, wherein each chemical mixture recipe comprises two or more ingredients;
assigningat least one ingredient in each chemical mixture recipe to one of pre-defined substance clusters, wherein each pre-defined substance cluster represents a single ingredient or a group of ingredients having similar chemistry;
revisingeach chemical mixture recipe by replacing the at least one ingredient with the assigned pre-defined substance cluster; and
providingthe revised chemical mixture recipes, together with the properties of the chemical mixture recipes, to a machine learning process in order to train a data-driven model, which is usable for predicting properties of a new chemical mixture.

2. The computer-implemented method according to claim 1, further comprising:
identifying, based on the training, a correlation between at least one pre-defined substance cluster and one or more characteristics of properties.

3. A computer-implemented method for predicting properties of a chemical mixture, comprising:
obtaininga chemical mixture recipe comprising two or more ingredients;
assigningat least one ingredient to one of pre-defined substance clusters, wherein each pre-defined substance cluster represents a single ingredient or a group of ingredients having similar chemistry;
revisingthe chemical mixture recipe by replacing the at least one ingredient with the assigned pre-defined substance cluster;
processingthe revised chemical mixture recipe with a data-driven model to predict property measurements of the chemical mixture recipe, wherein the data-driven model has been trained according to a method according to claim 1; and
outputtingthe predicted property measurements of the chemical mixture recipe.

4. The computer-implemented method according to claim 3, further comprising:
comparing the predicted property measurements to property performance targets; and
adjusting the chemical mixture recipe to meet the property performance targets.

5. The computer-implemented method according to claim 1,
wherein the properties of each chemical mixture recipe further comprise, for each measured property, a respective performance score indicative of a performance evaluation of the respective chemical mixture recipe.

6. The computer-implemented method according to claim 1,
wherein at least one ingredient selected from a resin and/or an additive is represented by a substance cluster.

7. The computer-implemented method according to claim 1,
wherein the chemical mixture comprises a paint formulation.

8. The computer-implemented method according to claim 7,
wherein the properties of a paint formulation comprise properties of a wet paint and/or properties of coating formed therefrom.

9. The computer-implemented method according to claim 1, wherein the chemical mixture comprises at least one selected from the group consisting of:
an agricultural multi-component mixture;
a pharmaceutical multi-component mixture;
a nutrition multi-component mixture;
an ink multi-component mixture;
a chemical mixture for construction purposes; and
a chemical mixture used inside oil production.

10. The computer-implemented method according to claim 1, wherein the data-driven model comprises a rule-based machine learning model.

11. The computer-implemented method according to claim 10,
wherein the rule-based machine learning model comprises at least one selected from the group consisting of:
learning classifier systems;
association rule learning; and
artificial immune systems.

12. A device comprising a training module configured to perform a method according to claim 1.

13. A device comprising a prediction module configured to perform a method according to claim 1.

14. A computer program product comprising a computer program with program code for performing a method according to claim 1.

15. A computer readable medium having stored the program element of claim 14.
